(19) United States
(12) Patent Application Publication
(10) Pub. No.: US 2005/0180430 A1
(43) Pub. Date: Aug. 18, 2005

(54) Packet communication device and method

(76) Inventors: Yuichi Kawaguchi, Kasuya-Gun (JP); Yoshifumi Sakata, Kasuga (JP)

Correspondence Address: WENDEROTH, LIND & PONACK, L.L.P., 2033 K STREET N. W., SUITE 800, WASHINGTON, DC, 20006-1021, US

(21) Appl. No.: 11/057,152

(22) Filed: Feb. 15, 2005

(30) Foreign Application Priority Data
Feb. 18, 2004 (JP) 2004-041084

(51) Int. Cl. H04L 12/28

(52) U.S. Cl. 370/395.41

(57) ABSTRACT

A packet receiver receives packets from other communication devices, and a resource reservation management table stores information of packets that needs resource reservation of a network. A resource allocation request unit detects a packet that corresponds to information of a reservation rule entry stored in the resource reservation management table, and makes a resource allocation request to the network. A communication period selecting unit selects a communication period to transmit the packet, according to the progress of situation of the resource allocation request to the network. A packet transmitter transmits the packet using the communication period selected from either of a first communication period and a second communication period.

### BACKGROUND OF THE INVENTION

1. Field of the Invention

The present invention relates to a packet communication device in a network that supports reservation of a network resource.

2. Description of the Related Art

In a network environment represented by the Internet, contents of information are divided into a plurality of packets, and communication is performed by transmitting these packets. Generally, transmission of packets is performed in a best effort mode. This means that communication of multimedia, such as audio and video, that requires real time processing, and communication of non-multimedia, such as an ftp, that does not require real time processing, are treated identically. As a result, when the network is crowded with the communication of non-multimedia such as the ftp, some packets are delayed to arrive or lost in the communication of multimedia such as the audio and the video, thereby causing breaks in the audio sound or quality deterioration of the video image.

In order to provide the communication of multimedia such as audio and video without quality deterioration, a network resource on a network path needs to be reserved and communication quality needs to be guaranteed.

IETF (Internet Engineering Task Force) provides a resource management protocol, such as RSVP (Resource Reservation Protocol), standardized as a reservation method for network resources in the Internet.

According to RSVP, before starting the multimedia communication, a network resource necessary for the multimedia communication is reserved on relay devices that constitute a network path to a communication partner. Therefore, when RSVP is used, communication quality is guaranteed.

The network resource is reserved by priority control in the relay devices and bandwidth allocation with priority in a wireless network. Such bandwidth allocation has been performed in power-line communication (PLC) and a wireless LAN. For example, in IEEE802.11e that can be applied to the wireless LAN, a contention access period by a distributed control type and a contention-free access period by a central control type are provided. In the contention access period, transmission opportunity can be acquired based on priority. In the contention-free access period, the transmission opportunity can be monopolistically acquired.

In the multimedia communication, when an allocation request of the network resource is made to the wireless network in advance and the contention-free access period is reserved for a definite period of time necessary for the multimedia communication, communication quality can be guaranteed.

On the other hand, all the terminals that perform the multimedia communication that needs resource reservation do not necessarily support such network resource reservation as mentioned above. In such a case, if a communication device is provided on a network path to issue, before the multimedia communication starts, an allocation request of a network resource that is necessary for the multimedia communication, instead of a terminal reserving the network resource in advance, then communication quality can be guaranteed.

When the terminal that does not support the network resource reservation starts communication that needs the network resource reservation, the communication device on the network path detects the communication and controls to allot the network resource necessary for the communication. According to the above method, even when the terminal does not reserve the network resource in advance, bandwidth allocation can be performed according to importance and other properties of packets, and communication quality can be guaranteed.

In resource reservation by RSVP, before a terminal starts the multimedia communication, a network resource needs to be reserved by a relay device in a network on a communication path. The network resource is necessary for performing the multimedia communication without quality deterioration. Therefore, the multimedia communication needs to start after completing the network resource reservation on the path, this may cause time lag by the time of the start of the multimedia communication.

Such time lag leads to a problem in multimedia communication in a home network, for example, in image viewing and listening that uses AV equipment, such as TV and VTR, connected to the home network. In short, there is a social common idea that these equipments in the home network can be used immediately, and a user does not allow such time lag. In order to get rid of such time lag, the terminal may start the multimedia communication before completing the reservation of the network resource. However, since the reservation of the network resource is not completed, the multimedia communication, which should be, in nature, guaranteed in communication quality, is treated same as other communications in best effort mode. Eventually, the communication quality of the multimedia communication is not guaranteed.

When the communication device on the path detects a multimedia communication to reserve a network resource in place of the terminal, the multimedia communication has already started at the moment when the communication device starts the reservation of the network resource. Therefore, the multimedia communication is treated as communication in the best effort mode and communication quality deteriorates during a period after the multimedia communication starts and until the reservation of the network resource is completed.

Since such deterioration of the communication quality leads to deterioration of quality in audio sound and video image, a user is not generous enough to allow such deterioration in communication quality.

As described above, an art performing the multimedia communication immediately without time lag with communication quality maintained is in need.

Since reservation of a network resource is an issue that is hard for a general user to understand, necessary communication control is desirable to be performed even when the user does not perform a setup.

### OBJECTS AND SUMMARY OF THE INVENTION

An object of the present invention is to provide a packet communication device that can guarantee communication quality of communication that needs reservation of a network resource before and after the reservation of the network resource is completed.

A first aspect of the present invention provides a packet communication device operable to compose a network substantially supporting a first communication period in which communications may be controlled at least by packet priority and may be carried out without reservation of network resources, and a second communication period in which communications may not be carried out without reservation of the network resources, the packet communication device comprising: a packet receiver operable to receive packets; a resource reservation information storage unit operable to store information on the reservation of the network resources; a resource allocation request unit operable to refer to the information stored in the resource reservation information storage unit and also operable to issue resource allocation request to the network to transmit the packets in the second communication period when the packets received by the packet receiver are judged to need reserving the network resources; a communication period selecting unit operable to select either of the first communication period and the second communication period to transmit the packets; and a packet transmitter operable to transmit the packets using the communication period selected by the communication period selecting unit. The communication period selecting unit is operable to select the first communication period before completion of reserving the network resources in response to the resource allocation request issued by the resource allocation request unit. The communication period selecting unit is operable to select the second communication period after the completion of reserving the network resources.

According to the construction described above, for the packets that need reservation of a network resource, communication is performed in the first communication period based on the priority during reserving the network resource, and communication is performed in the second communication period after completing the reservation. Therefore, communication quality of the packets that needs resource reservation can be guaranteed.

A second aspect of the present invention provides the packet communication device as defined in the first aspect, wherein the packet receiver comprises a plurality of packet receiving units, and wherein priority of a packet that needs reserving the network resources is determined depending on which of the packet receiving units receives the packet that needs reserving the network resources.

According to the construction described above, priority of the packets that is necessary in the first communication period can be set up individually for every packet receiving units of the packet communication device, therefore the setup of the priority can be performed easily, even when a user does not perform a special setup.

A third aspect of the present invention provides the packet communication device as defined in the first aspect, wherein the packet communication device further comprises a resource measuring unit operable to measure reservation parameters currently necessary for packets that need reserving the network resources according to the information stored in the resource reservation information storage unit.

According to the construction described above, a user does not have to set up reservation parameters necessary for reservation; thereby the setup of the reservation parameters can be simply made.

A fourth aspect of the present invention provides the packet communication device as defined in the third aspect, wherein the packet communication device further comprises a resource monitoring unit operable to judge whether re-reservation of the network resources is necessary for packets that need reserving the network resources according to the information stored in the resource reservation information storage unit, by comparing the reservation parameters included in the resource allocation request issued by the resource allocation request unit and the currently necessary reservation parameters determined by the resource measuring unit, and wherein when the resource monitoring unit judges that the re-reservation of the network resources is necessary, the resource allocation request unit is operable to issue resource allocation request based on the currently necessary reservation parameters.

The above-described construction can deal with communication in which the reservation parameters (traffic characteristics) are changeable, and can guarantee communication quality of the packets that need the resource reservation.

A fifth aspect of the present invention provides the packet communication device as defined in the fourth aspect, wherein, before completion of reserving the network resources in response to the resource allocation request based on the currently necessary reservation parameters issued by the resource allocation request unit, the packet communication device is operable to transmit the packets that need reserving the network resources using both of the first communication period and the second communication period only when the packets cannot be transmitted in the second communication period alone.

According to the construction described above, even when more traffic occurred than reserved, packets exceeding what is defined by the reserved parameters are transmitted in the first communication period with priority, thereby guaranteeing communication quality of the corresponding packets.

A sixth aspect of the present invention provides a packet communication device operable to compose a network substantially supporting a first communication period in which communications may be controlled at least by packet priority and may be carried out without reservation of network resources, and a second communication period in which communications may not be carried out without reservation of the network resources, the packet communication device comprising: a packet receiver operable to receive packets; a packet transmitter operable to transmit the packets received by the packet receiver in either of the first communication period and the second communication period in accordance with kinds of the packets; and a resource allocation request unit operable to issue resource allocation request to the network, thereby transmitting packets that needs reserving the network resources in the second communication period, wherein the packet transmitter is operable, according to the progress of the resource allocation request, to select either of the first and second communication periods to transmit the packets that need reserving the network resources.

According to the construction described above, for packets that needs reserving the network resource, an optimal communication period can be selected according to the reservation status of the network resource, therefore, communication quality of the packets can be guaranteed.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a packet communication device in a first embodiment of the present invention;

FIG. 2 is a block diagram of a network in the first embodiment of the present invention;

FIG. 3 is a block diagram of hardware of a packet communication device in the first embodiment of the present invention;

FIG. 4 illustrates packets transmitted in first and second communication periods in a network 1 in the first embodiment of the present invention;

FIG. 5 is a flowchart of a resource allocation request unit in the first embodiment of the present invention;

FIG. 6 is a flowchart of a resource allocation request unit in the first embodiment of the present invention;

FIG. 7 is a flowchart of a communication period selecting unit in the first embodiment of the present invention;

FIG. 8 is a flowchart of a packet transmitter in the first embodiment of the present invention;

FIG. 9 illustrates a resource reservation management table in the first embodiment of the present invention.

FIG. 10 is a block diagram of a packet communication device comprising a plurality of packet receivers in the first embodiment of the present invention;

FIG. 11 is a block diagram of a packet communication device in a second embodiment of the present invention;

FIG. 12 is a flowchart of a resource measuring unit in the second embodiment of the present invention;

FIG. 13 is a flowchart of a resource monitoring unit in the second embodiment of the present invention;

FIG. 14 is a flowchart of a resource allocation request unit in the second embodiment of the present invention;

FIG. 15 is a flowchart of a resource allocation request unit in the second embodiment of the present invention;

FIG. 16 is a flowchart of a packet communication unit in the second embodiment of the present invention; and

FIG. 17 illustrates a resource reservation management table in the second embodiment of the present invention.

### DETAILED DESCRIPTION OF THE PREFERRED EMBODIMENTS

Hereafter, embodiments of the present invention are now described with reference to the accompanying drawings.

(First Embodiment)

FIG. 1 is a block diagram of a packet communication device in a first embodiment of the present invention.

A packet communication device 10 of the present embodiment comprises a resource reservation management table 2, a packet receiver 3, a resource allocation request unit 4, a communication period selecting unit 5, a packet transmitter 6, and a reservation controlling unit 9.

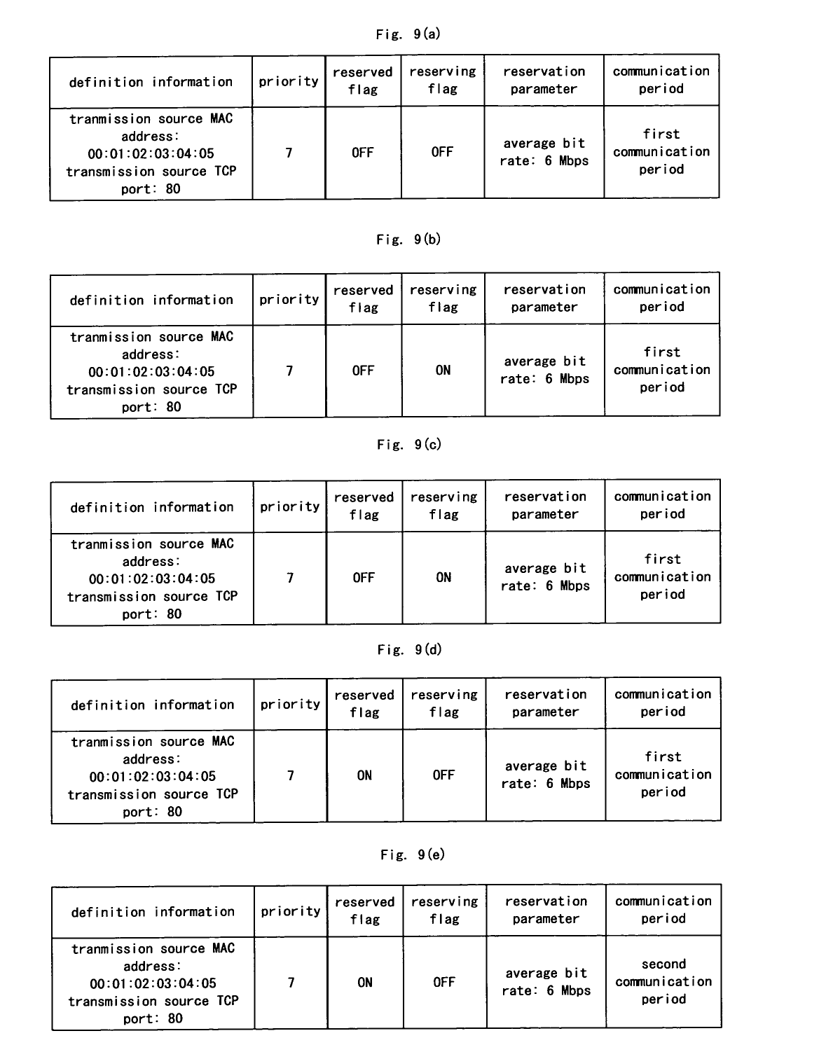

The resource reservation management table 2 is equivalent to a resource reservation information storage unit, and stores resource reservation information of packets. In the present embodiment, the resource reservation management table 2 manages resource reservation information as a set of a reservation rule shown in FIG. 9. Each reservation rule is expressed by one of the reservation rule entries of the resource reservation management table 2, and each reservation rule entry possesses a plurality of fields described in the following. Of course, the resource reservation information storage unit is not limited to a table, and may alternatively be formed by a well-known storage format, such as an array and a list.

A value of a “definition information” field is for classifying packets, and includes an MAC address value of a transmitting source and a TCP port value of a transmitting source. The “definition information” field describes the rule for classifying packets. The value of the “definition information” field can be arbitrarily determined as long as the value is included in each packet header, such as an MAC header, an IPv4 header, an IPv6 header, a TCP header, and a UDP header, which are used in the Internet.

A value of a “priority” field shows a level of the priority. In the present embodiment, eight steps of priority defined by IEEE802.1p are used as the level of the priority. A value “7” is the highest priority, and the packet, whose priority is a value “0”, is treated in a “best effort mode.” The priority of the packet whose reservation rule entry does not exist shall be treated as the value “0”, and the first communication period 16 shall be used as the communication period.

A value of a “reserved flag” field (“ON” or “OFF”) shows whether the reservation is made or not. When the value of the “reserved flag” field is “OFF”, the reservation of the network resource regarding the corresponding reservation rule has not been completed, and when the value is “ON”, the reservation has been completed.

A value of a “reserving flag” field (“ON” or “OFF”) shows whether the reservation is in progress or not.

A value of a “communication period” field shows whether the reservation rule entry corresponds to the first communication period (an period that communication without reservation is permissible, such as a CSMA period) or the second communication period (an period that communication without reservation is not permissible, such as a TDMA period).

A value of a “reservation parameter” field is a value to be designated to a network at the time of reservation of a network resource. In the present embodiment, an average bit rate shall be used as the value of the “reservation parameter” field.

The values of the fields of “definition information”, “priority”, and “reservation parameter” may be beforehand set in the packet communication device, may be designated by a user via GUI etc., and may be set up via networks.

The packet receiver 3 receives packets that are sent from the other communication devices.

The resource allocation request unit 4 detects packets corresponding to the reservation rule, which the resource reservation management table 2 possesses, and issues a resource allocation request to the network.

The communication period selecting unit 5 selects either the first communication period or the second communication period as the communication period to transmit corresponding packets, according to the progress of state in the resource allocation request to the network, for example, whether the resource allocation request has completed or not.

The packet transmitter 6 transmits the packets using the communication period which the communication period selecting unit 5 has selected.

The reservation controlling unit 9 mediates the processing of the resource reservation management table 2, the resource allocation request unit 4, and the communication period selecting unit 5, bringing these elements under control. In particular, the reservation controlling unit 9 operates the reservation rule entry of the resource reservation management table 2 according to the situation.

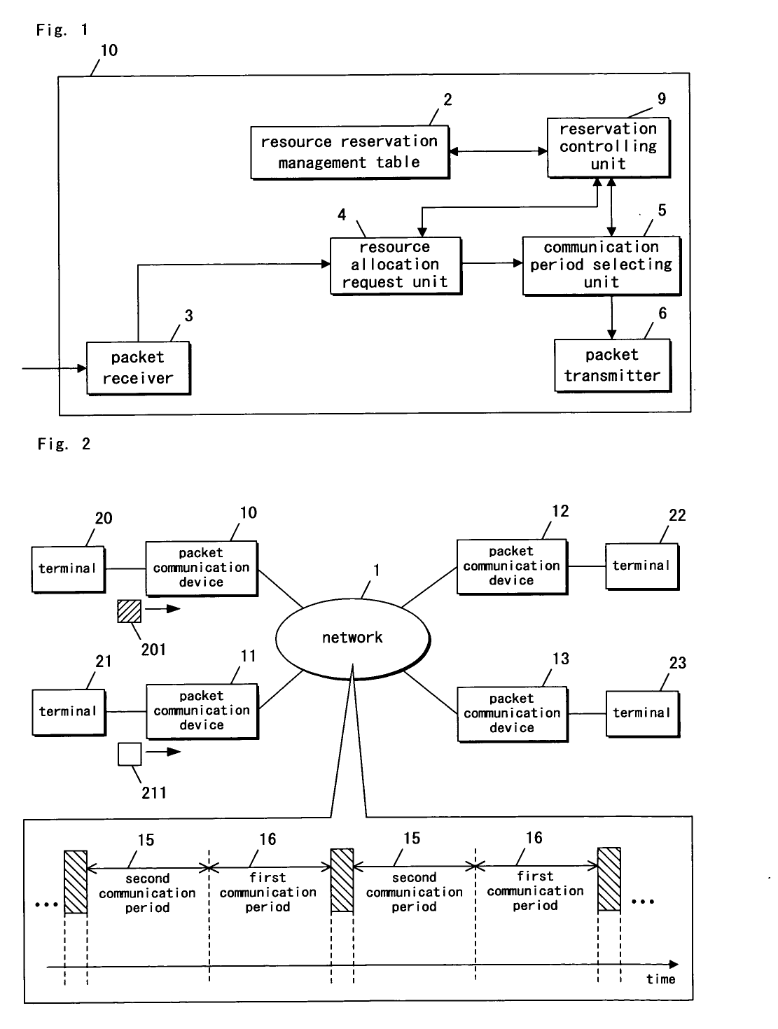

FIG. 2 shows the network in the first embodiment of the present invention.

A network 1 supports two communication periods, the second communication period 15 and the first communication period 16, as communication periods to transmit packets. These communication periods in the present embodiment are described in the following. The transmission opportunity according to the priority of packets is allotted in the first communication period 16. In short, the communication can be performed without reservation in the first communication period 16. In the second communication period 15, the communication, whose bandwidth is guaranteed based on the reservation of the network resource, is performed. In short, the communication can not be performed without reservation in the second communication period 15.

Terminals 20, 21, 22, and 23 transmit and receive packets, respectively. A packet 201 is transmitted to the terminal 22 from the terminal 20, and a packet 211 is transmitted to the terminal 23 from the terminal 21.

The terminal 20 is connected to the packet communication device 10, the terminal 21 is connected to a packet communication device 11, the terminal 22 is connected to a packet communication device 12, and the terminal 23 is connected to a packet communication device 13. The packet communication devices 10, 11, 12, and 13 are connected each other via the network 1. Packet communication devices 10, 11, 12, and 13 transfer packets, which have been transmitted by the terminals 20, 21, 22, and 23, to terminals that receive the packets.

Since the packet communication devices 11-13 are structured as same as the communication device 10 is structured, the explanation for the packet communication devices 11-13 is omitted.

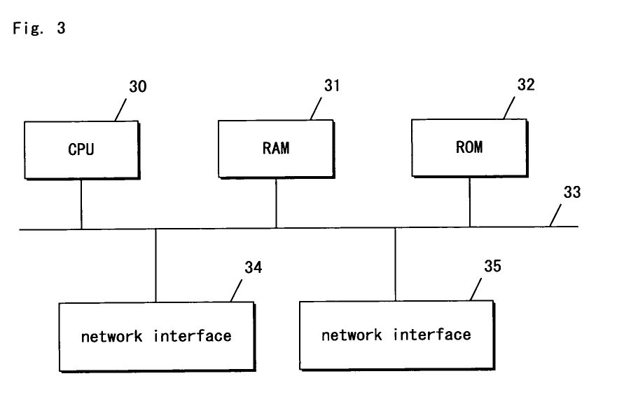

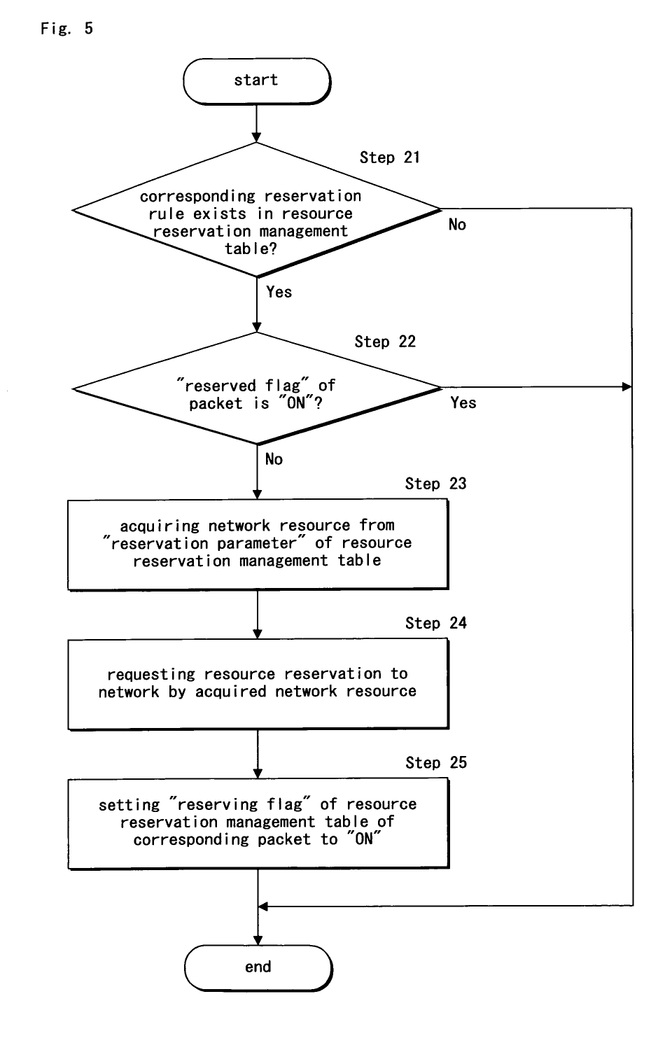

FIG. 3 is a hardware block diagram of the packet communication device 10 in the embodiment 1 of the present invention. The system program described according to the flowcharts shown in FIGS. 5-8 and FIGS. 12-16 is stored in a ROM 32 of FIG. 3, and is loaded to a CPU 30 via a bus 33. The CPU30 executes the system program and controls operation of each element of FIG. 1.

A storing area required by the CPU 30 for the processing and a storing area used for the resource reservation management table 2 are secured in the RAM31. The packet receiver 3 and the packet transmitter 7 are realized when network interfaces 34 and 35 output to and input from the network 1 under the control of the CPU 30.

In the present embodiment, the terminal 20 is a transmitting terminal to transmit packets that require reservation, and the terminal 22 is a receiving terminal to receive the packets from the terminal 20. The terminal 21 is a transmitting terminal to transmit packets that do not require reservation, and the terminal 23 is a terminal to receive the packets from the terminal 21.

(1) Transmission steps of a packet that is transmitted to the terminal 23 from the terminal 21

A step which the packet communication device 11 processes the packet 211 to transmit from the terminal 22 to the terminal 23 is explained by using FIGS. 2, 5, 7, and 8. This step is the transmission step of the packet 211 which does not have a corresponding reservation rule entry, In the present embodiment, it is supposed that the resource reservation management table 2 of the packet communication device 11 does not possess the reservation rule entry at all.

First, the terminals 21 and 23 establish socket communication and the terminal 21 starts transmission of the packet 211.

The packet receiver 3 of the packet communication device 11 receives the packet 211 from the terminal 21, and the packet 211 is outputted to the resource allocation request unit 4. The resource allocation request unit 4 accesses the resource reservation management table 2 via the reservation controlling unit 9. In FIG. 5, since the reservation rule entry does not exist in the resource reservation management table 2 of the packet communication device 11, the resource allocation request unit 4 does not perform at all, and the processing ends (Step 21).

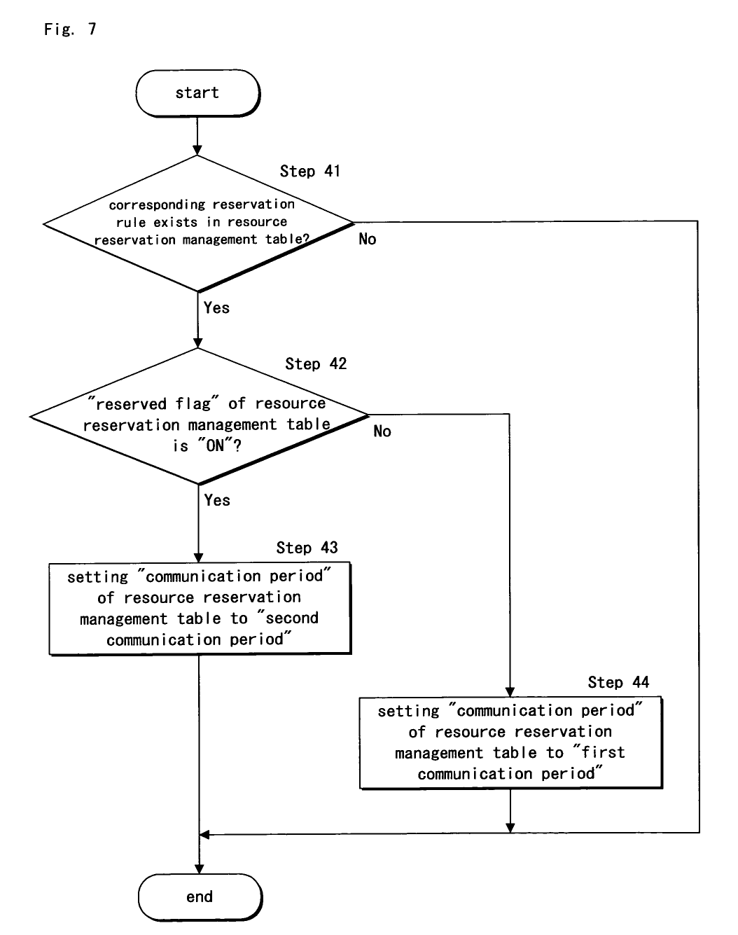

In FIG. 7, the communication period selecting unit 5 of the packet communication device 11 accesses the resource reservation management table 2 via the reservation controlling unit 9. Since the reservation rule entry regarding the packet from the terminal 21 to the terminal 23 does not exist in the resource reservation management table 2, the communication period selecting unit 5 does not perform at all, and the processing ends (Step 41).

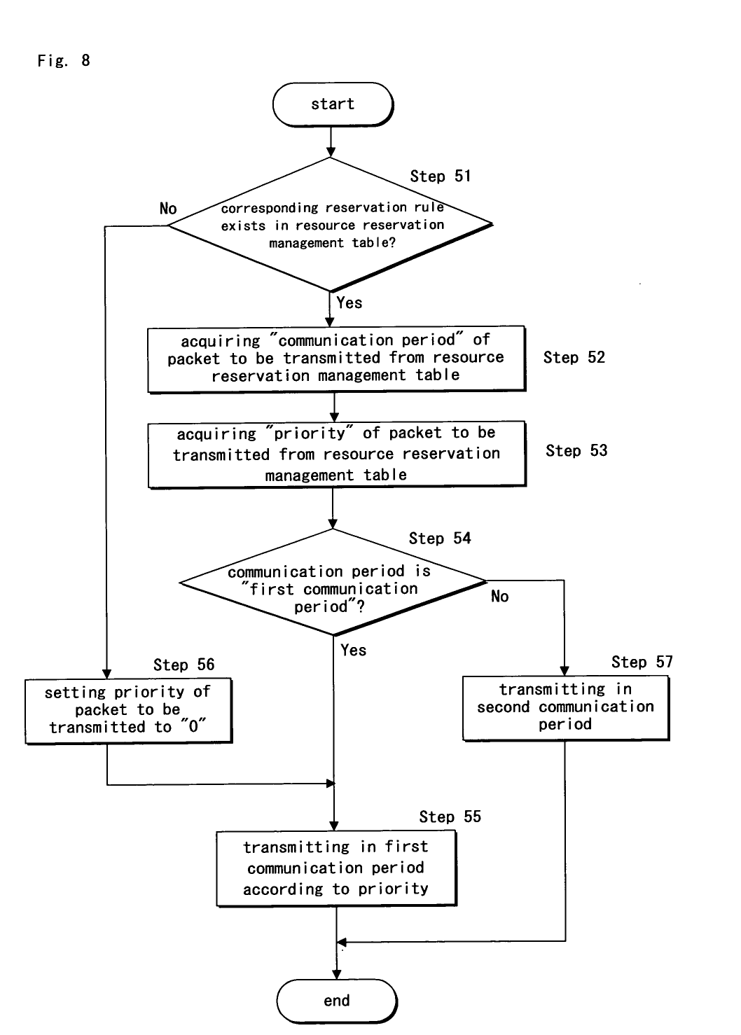

In FIG. 8, the packet transmitter 6 of the packet communication device 11 accesses the resource reservation management table 2 via the reservation controlling unit 9. Since the rule regarding the packet from the terminal 21 to the terminal 23 does not exist in the resource reservation management table 2 (Step 51), the packet transmitter 6 sets the priority value of the packet 211 as “0” (Step 56), and transmits the packet 211 in the first communication period 16 (Step 55).

Through the above-mentioned processing, the priority “0” is given for the packet 211 to be sent from the terminal 21 to the terminal 23 in the network 1, and the packet is transmitted in the first communication period 16.

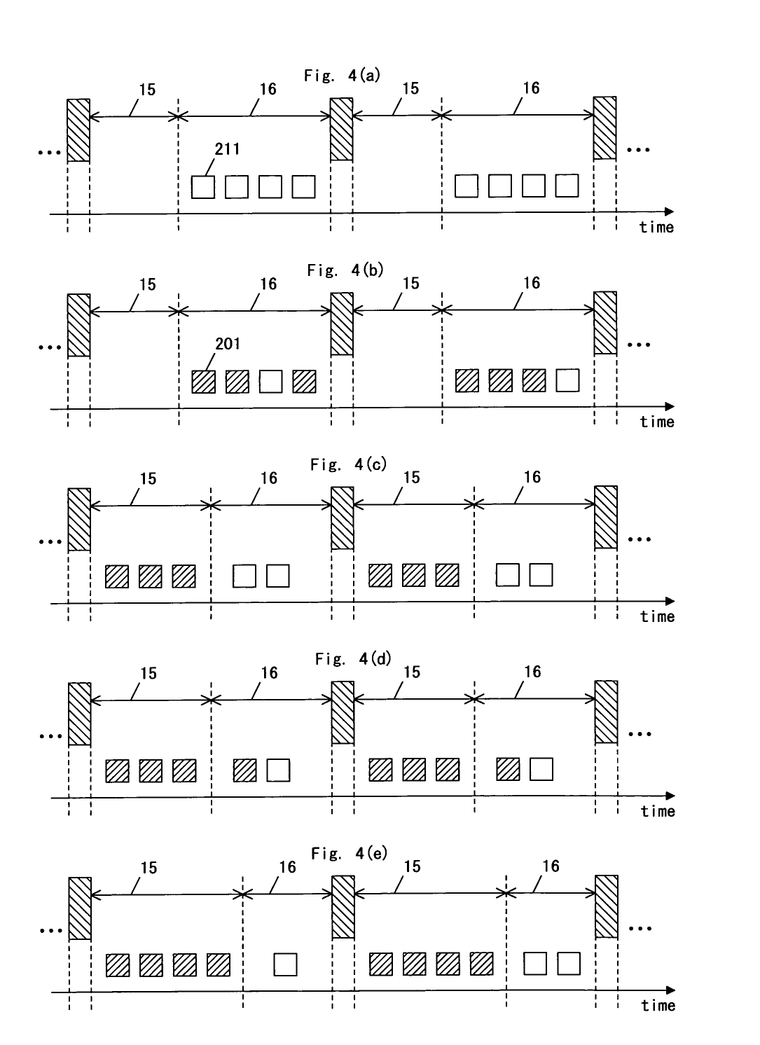

FIG. 4(a) shows a communication state of the network 1 at this time, and the packet 211 is transmitted in the first communication period 16.

(2) Transmission steps of a packet that is transmitted to the terminal 22 from the terminal 20 (before the reservation completed)

The transmission step of the packet 201 from the terminal 20 to the terminal 22 is explained, using FIGS. 2 and 9. This step is the transmission step of the packet 201 whose reservation rule entry exists, but before the reservation of the network resource is completed.

It is supposed that the reservation rule entry shown in FIG. 9(a) is described in the packet communication device 10.

First, the terminals 20 and 22 establish socket communication. It is supposed that the terminal 20, a transmitting source, transmits the packet 201 having the transmitting source MAC address of “00:01:02:03:04:05” and the transmitting source TCP port number of “80”.

The packet receiver 3 of the packet communication device 10 receives the packet 201 from the terminal 20, and the packet 201 is outputted to the resource allocation request unit 4.

Next, operation of the resource allocation request unit 4 is explained using FIGS. 5 and 9.

In FIG. 5, the resource allocation request unit 4 accesses the resource reservation management table 2 via the reservation controlling unit 9, and confirms whether or not the packet 201 corresponds to the reservation rule entry of the resource reservation management table 2 (Step 21). In the present embodiment, the resource reservation management table 2 of the packet communication device 10 possesses the reservation rule entry shown in FIG. 9(a). The MAC address “00:01:02:03:04:05” and the transmitting source TCP port number “80” of the terminal 20 correspond to the reservation rule that is defined by the values of the “definition information” field.

Therefore, in FIG. 5, the resource allocation request unit 4 accesses the resource reservation management table 2 via the reservation controlling unit 9, and confirms whether or not the value of the “reserved flag” field of the corresponding reservation rule entry is “ON” (Step 22). In FIG. 9(a), the “reservation flag” field is “OFF.”

Therefore, the resource allocation request unit 4 acquires a value “average bit rate 6 Mbps” from the “reservation parameter” field of the resource reservation management table 2 as a network resource (Step 23).

The resource allocation request unit 4 executes resource reservation to the network 1 by the acquired network resource (Step 24). After the resource reservation execution, the reservation controlling unit 9 updates the value of the “reserving flag” field of the resource reservation management table 2 from “OFF” to “ON” (Step 25). Thereby, the resource reservation management table 2 becomes in the state of FIG. 9(b). However, the value of the “reserved flag” field is still “OFF” until reservation is completed.

Next, operation of the communication period selecting unit 5 is explained using FIGS. 7 and 9.

In FIG. 7, the communication period selecting unit 5 accesses the resource reservation management table 2 via the reservation controlling unit 9, and confirms whether or not the packet corresponds to that is possessed by the resource reservation management table 2 (Step 41).

For the packet whose reservation rule entry is possessed, the communication period selecting unit 5 accesses the resource reservation management table 2 via the reservation controlling unit 9, and confirms whether or not the “reserved flag” field of the resource reservation management table 2 is “ON” (Step 42). In the present resource reservation management table 2, since the value of the “reserved flag” field is “OFF” as shown in FIG. 9(b), the communication period selecting unit 5 accesses the resource reservation management table 2 via the reservation controlling unit 9, and sets the value of the “communication period” field of the resource reservation management table 2 as the “first communication period” (Step 44).

Thus, the resource reservation management table 2 becomes as shown in FIG. 9 (c).

In the following, operation of the packet transmitter 6 is explained using FIGS. 8 and 9.

First, in FIG. 8, the packet transmitter 6 accesses the resource reservation management table 2 via the reservation controlling unit 9, and confirms whether or not the packet 201 to be transmitted corresponds to the reservation rule entry that is possessed by the resource reservation management table 2 (Step 51).

As shown in FIG. 9(a), since the packet 201 is a packet for which the corresponding reservation rule entry is possessed, the packet transmitter 6 accesses the resource reservation management table 2 via the reservation controlling unit 9, and the packet transmitter 6 acquires the communication period to transmit the packet 201 from the “communication period” field of the resource reservation management table 2 (Step 52). The packet transmitter 6 acquires a priority from the “priority” field (Step 53), and confirms whether or not the acquired communication period is the “first communication period” (Step 54).

As shown in FIG. 9(a), the communication period of the packet 201 to be used for the communication from the terminal 20 to the terminal 22 is the “first communication period”, and the priority is “7”.

Therefore, in the packet communication device 10, the packet from the terminal 20 to the terminal 22 is transmitted by using the first communication period 16 with the priority “7” (Step 55).

As shown in FIG. 4(b), until the reservation of the network resource has completed, the packet 201 to be sent from the terminal 20 to the terminal 22 is transmitted with the higher priority than the packet 211 to be sent from the terminal 21 to the terminal 23 in the network 1.

Therefore, the packet 201 is protected by the high priority and is not easily abandoned even in a period when the reservation has not been established. As a result, the communication quality related to the packet 201 can be improved.

(3) Transmission steps of a packet that is transmitted from the terminal 20 to the terminal 22 (after the reservation completed)

The transmission steps are explained for the packet from the terminal 20 to the terminal 22, after the packet communication device 10 completes reservation of the network resource related to the communication from the terminal 20 to the terminal 22.

Since operation of the packet receiver 3 is as same as the above-mentioned operation, the explanation is omitted.

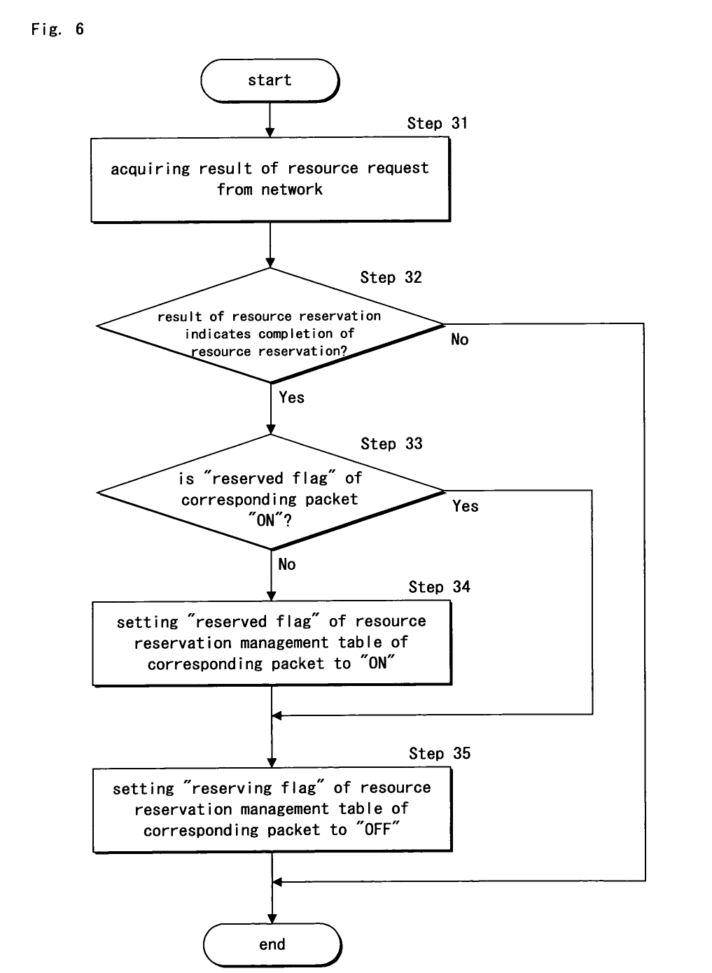

FIG. 6 is a flowchart illustrating operation when the resource allocation request unit 4 receives the resource reservation result that is performed at Step 24.

The resource allocation request unit 4 acquires the result of the resource allocation request from the network 1 (Step 31). Here, it is supposed that reservation of the resource is succeeded and a result of the completion is received. At that moment, the resource allocation request unit 4 judges the resource reservation is completed (Step 32), and confirms whether or not the “reserved flag” field of the reservation rule entry of the resource reservation management table 2 is “ON”, via the reservation controlling unit 9 (Step 33).

As shown in FIG. 9(c), since the “reserved flag” field is “OFF”, the resource allocation request unit 4 updates the “reserved flag” field of the resource reservation management table 2 to “ON” via the reservation controlling unit 9 (Step 34), and updates the “reserving flag” field to “OFF” (Step 35). Thereby, the resource reservation management table 2 becomes as shown in FIG. 9(d).

In the following, operation of the communication period selecting unit 5 after the completion of the network resource reservation is explained using FIG. 7.

The communication period selecting unit 5 accesses the resource reservation management table 2 via the reservation controlling unit 9, and confirms whether or not the packet to be transmitted corresponds to the reservation rule entry that is possessed by the resource reservation management table 2 (Step 41).

For the packet whose reservation rule entry is possessed, the communication period selecting unit 5 confirms whether or not the “reserved flag” field of the resource reservation management table 2 is “ON” (Step 42). As shown in FIG. 9(d), since the “reserved flag” field is “ON” in the present resource reservation management table 2, the “communication period” field of the resource reservation management table 2 is set to the “second communication period” (Step 44).

Thus, the resource reservation management table 2 becomes as shown in FIG. 9 (e).

In the following, operation of the packet transmitter 6 after the completion of the network resource reservation is explained using FIG. 8.

First, the packet transmitter 6 accesses the resource reservation management table 2 via the reservation controlling unit 9, and confirms whether or not the packet to be transmitted corresponds to the reservation rule entry that is possessed by the resource reservation management table 2 (Step 51).

For the packet whose reservation rule entry is possessed, the packet transmitter 6 accesses the resource reservation management table 2 via the reservation controlling unit 9, acquires the communication period to transmits the packet from the “communication period” field of the resource reservation management table 2 (Step 52), then acquires the priority from the “priority” field (Step 53), and confirms whether or not the acquired communication period is the “first communication period” (Step 54).

As shown in FIG. 9(e), since the communication period for the packet to be transmitted from the terminal 20 to the terminal 22 is set as the “second communication period”, the packet is transmitted in the second communication period (Step 57).

In the packet communication device 10, the packet from the terminal 20 to the terminal 22 is transmitted by using the second communication period 15 whose network resource is already reserved for the packet.

FIG. 4(c) illustrates the state of the network 1 at this moment, and the packet 201 is transmitted in the second communication period 15 and the packet 211 is transmitted in the first communication period 16.

In case where the packet requiring the reservation of the network resource is transmitted, the packet is transmitted in the first communication period 16 with higher priority than others, until the reservation of the network resource is completed. After the reservation of the network resource is completed, the packet is transmitted in the second communication period 15, which uses the reservation allocated to the packet. Therefore, the deterioration in communication quality can be suppressed.

In the present embodiment, the terminal and the packet communication device are illustrated as different bodies; however, the terminal and the packet communication device may be formed as one body.

Although there are two selectable communication periods in the present embodiment, the communication periods may be more than three in number, and the same effect can be obtained. In the present embodiment, the selection of the communication periods is decided by either one of the two states, one is the state where the reservation of the network resource is completed and the other is the state where the reservation of the network resource is not completed. However, the number of the communication periods can be increased according to the number of states (for example, “reserving network resource”, “reservation is in hold because of lack of bandwidth”, “reservation is completed”, and others), and one of the communication periods may be selected.

In the first communication period 16, the initial value of the “priority” field does not have to be “0”, and may be a different value. The initial value does not always have to be fixed. The initial value may be updated based on the state, for example, assigning the highest priority for the initial value for one second after the reservation of the network resource is made, and assigning the lowest priority after ten seconds have passed.

The priority may be set based on the packet receiver 3, which has received the packet indicated in the reservation rule entry. For example, as shown in FIG. 10, a plurality of packet receiving units 301, 302, and 303 form the packet receiver of the packet communication device 10. For example, when the packet receiving unit 301 receives the packet indicated in the reservation rule entry, the priority is “7”, when the packet receiving unit 302 receives the packet, the priority is “5”, and when the packet receiving unit 303 receives the packet, the priority is “4”.

In the present embodiment, transmission by the second communication period 15 that can acquire the transmission opportunity monopolistically, and the first communication period 16 that can acquire the transmission opportunity, are described as an example. It should be understood that the present invention is applicable to a wireless LAN and a power line communication that can provide a plural communication periods as mentioned above.

Even when the network (for example: Ethernet (registered trademark)) does not support the first communication period 16 and the second communication period 15, it is sufficient enough as long as the packet communication device performs the bandwidth guarantee control based on the resource reservation and the transfer control based on the priority of the packet, and the packet is transferred under the priority control until the reservation is completed, and is transferred under the bandwidth guarantee control after the reservation is completed. In this case, the network substantially supports the first communication period and the second communication period in relation to the present invention. Therefore, the case described above is included in the range of the present invention and exhibits the same effect as the present invention.

The example of transmission using the first communication period, which can acquire the transmission opportunity based on the priority, is described in the present embodiment. The transmission may be alternatively performed in a tentative reservation period instead of the first communication period until the resource reservation is completed, and the transmission may be performed in the second communication period after the resource reservation is completed. The tentative reservation period is like an period that Intelligent TDMA, which is disclosed in the non-patent reference 2, reserves a tentative reservation bandwidth (for example, approximately 1 Mbps).

According to the alternative structure described above, the bandwidth is guaranteed when the bandwidth of the packet requiring the reservation is less than the tentative reservation bandwidth, and even when the bandwidth is greater than the tentative reservation bandwidth, the most available bandwidth can be allocated by the Intelligent TDMA. Therefore, the same effect as in the present invention can be obtained before the reservation of the network resources is completed.

(Second Embodiment)

In the second embodiment, a packet communication device further comprises a resource measuring unit 7 and a resource monitoring unit 8 in addition to the structure of the first embodiment.

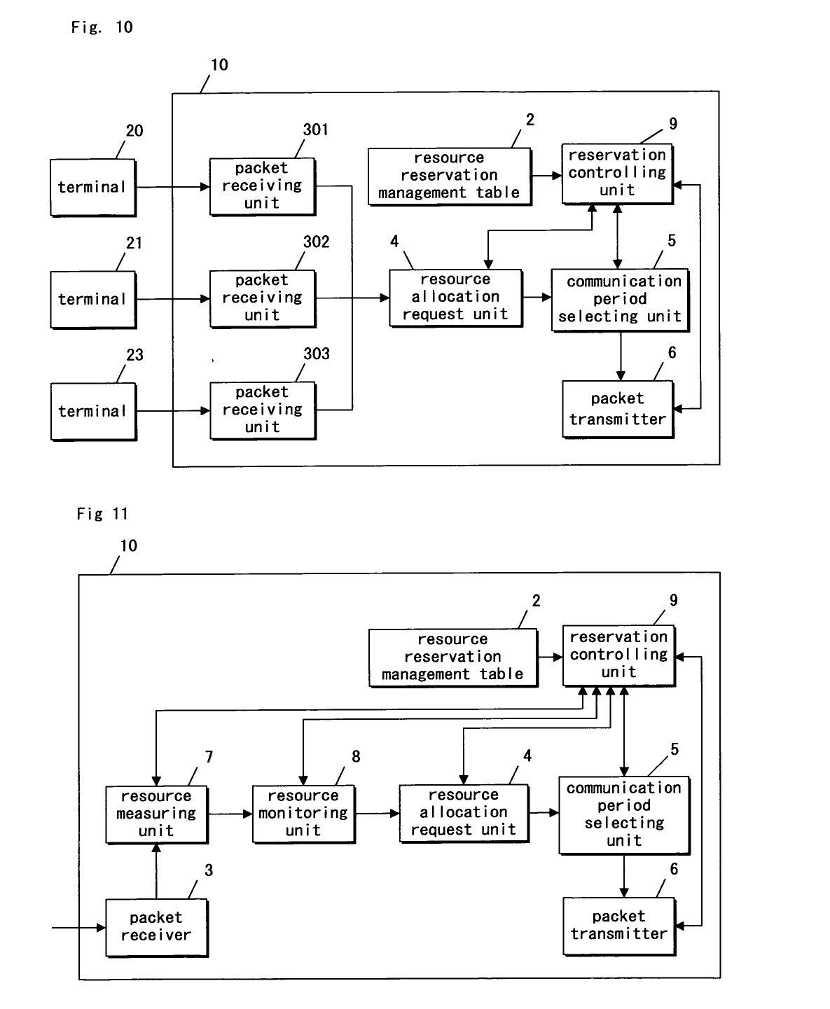

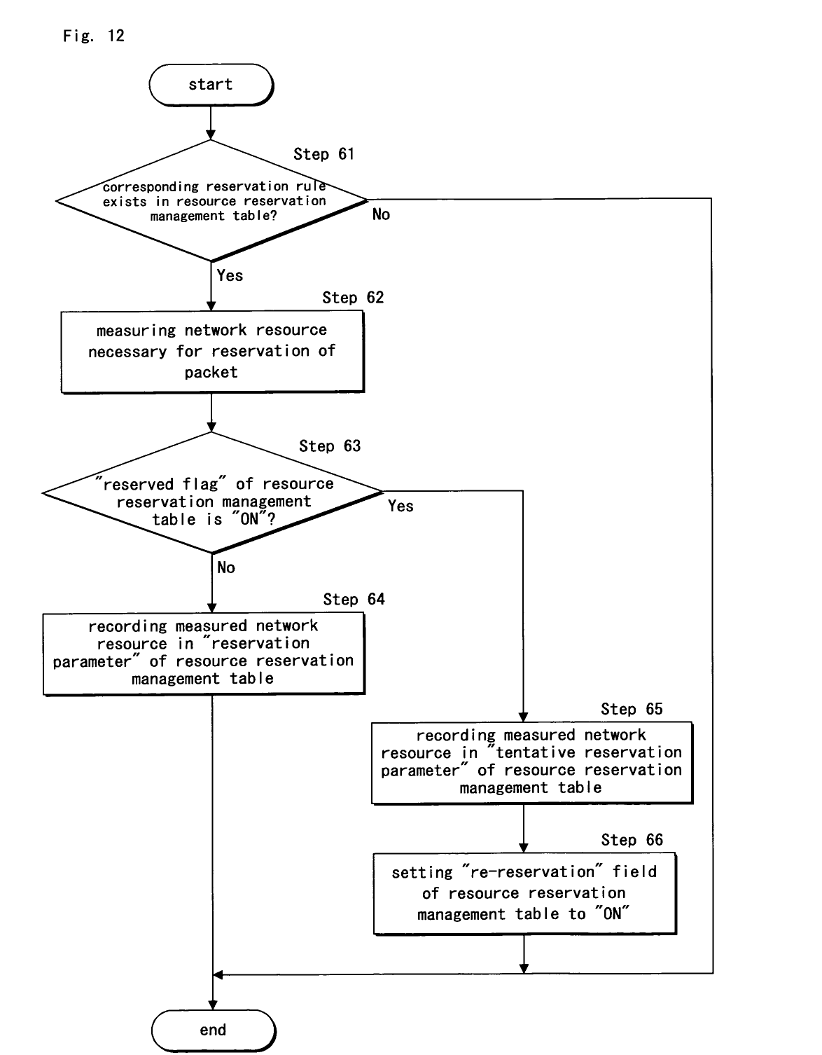

FIG. 11 is a block diagram of the packet communication device in the second embodiment of the present invention. The same symbols are given to the same components as FIG. 1, and the explanation is omitted.

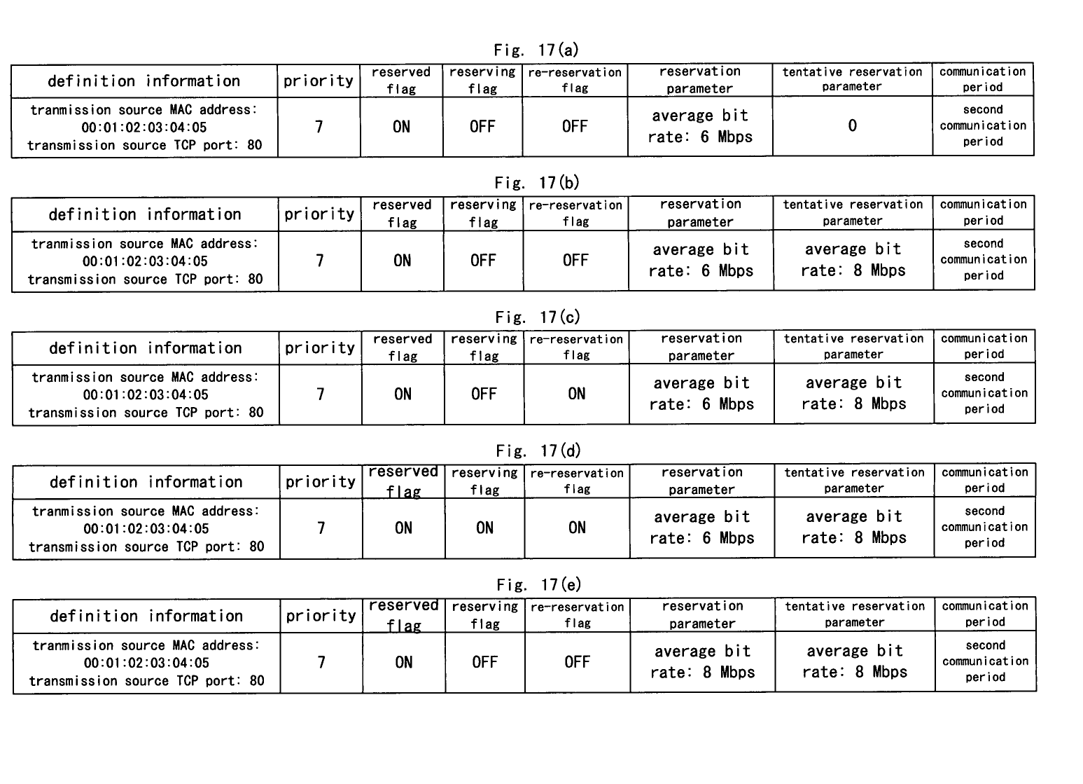

As shown in FIG. 17, the reservation rule entry of the resource reservation management table 2 of the second embodiment comprises a “re-reservation flag” field and a “tentative reservation parameter” field in addition to the fields of FIG. 9

In the present embodiment, when the reservation rule entry regarding the packet requiring the resource reservation, that is, when the definition information and the priority are specified, the value of the “tentative reservation parameter” is set to “0”, and the value of the “re-reservation flag” is set to “OFF”. The value “OFF” of the “re-reservation flag” indicates that the reservation of the network resource does not need to be made again, and the value “ON” of the “re-reservation flag” indicates that the reservation has to be made again.

The resource measuring unit 7 measures a necessary reservation parameter at present regarding the packet corresponding to the reservation rule entry, which the resource reservation management table 2 possesses. Then, the resource measuring unit 7 stores the measured result on the “reservation parameter” field or the “tentative reservation parameter” field of the reservation rule entry via the reservation controlling unit 9.

The resource monitoring unit 8 compares the value of the “reservation parameter” and the value of the “tentative reservation parameter” which the resource reservation management table 2 possesses. When the comparison result is larger than the fixed value (10% difference in the present embodiment), the resource monitoring unit 8 records that the re-reservation is necessary on the reservation rule entry. More specifically, the record can be practiced by changing the value of the “re-reservation flag” field from the value “OFF” to the value “ON”.

The present embodiment is explained for operation after the series of processing (1), (2), and (3) of the first embodiment are completed. In FIG. 2, the terminal 20 completes the reservation of the network, and communicates with the terminal 22 using the second communication period 15. The terminal 21 communicates with the terminal 23 using the first communication period 16, as shown in FIG. 4(c).

The resource reservation management table 2 is as shown in FIG. 17(a), and the values of the fields of “definition information”, “priority”, “reserved flag”, “reserving flag”, “reservation parameter”, and “communication period” are the same as those of FIG. 9(e).

The value of the “re-reservation flag” field is “OFF”, and the value of the “tentative reservation parameter” field is “0.”

Differences between the present embodiment and the first embodiment are mainly explained in the following.

(4) Transmission steps of a packet that is transmitted from the terminal 20 to the terminal 22 (before the re-reservation completed)

Regarding the transmission from the terminal 20 to the terminal 22, steps to transmit a packet from the terminal 20 to the terminal 22 in the present embodiment are explained. The steps are processed between the time when the packet communication device 10 issues the re-reservation request with a new reservation parameter and the time when the re-reservation is completed.

The packet receiver 3 receives the packet, and outputs the received packet to the resource measuring unit 7.

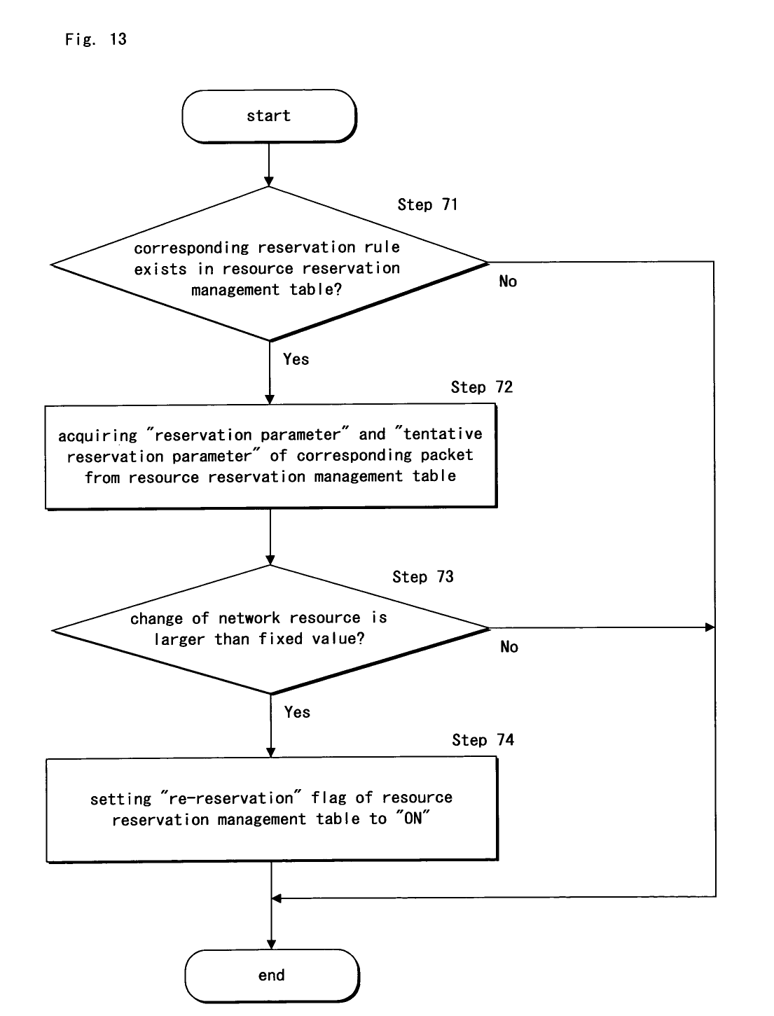

Next, operation of the resource measuring unit 7 is explained referring to FIG. 12. The resource measuring unit 7 confirms whether or not the resource reservation management table 2 possesses the reservation rule entry corresponding to the packet via the reservation controlling unit 9 (Step 61). As shown in FIG. 17(a), since the resource reservation management table 2 possesses the reservation rule entry, the resource measuring unit 7 measures a network resource (Step 62). In the present embodiment, it is supposed that the measurement of the necessary network resource is performed based on the average bit rate, and a measured result “average bit rate 8 Mbps” is acquired.

After the measurement, the resource measuring unit 7 confirms whether or not the value of the “reserved flag” field of the reservation rule entry is “ON” via the reservation controlling unit 9 (Step 63). When the value is “OFF” (with no reservation), the resource measuring unit 7 records the measured result on the “reservation parameter” field via the reservation controlling unit 9 (Step 64).

On the other hand, when the value of the “reserved flag” field is “ON” (reservation is completed), the resource measuring unit 7 records the measured result on the “tentative reservation parameter” field via the reservation controlling unit 9, and sets the value of the “re-reservation flag” field to “ON” (Step 66).

In the present embodiment, as shown in FIG. 17(a), since the value of the “reserved flag” field is “ON”, the resource measuring unit 7 records “average bit rate 8 Mbps” as the measured result on the “tentative reservation parameter” field via the reservation controlling unit 9. As a result, the resource reservation management table 2 becomes as shown in FIG. 17(b).

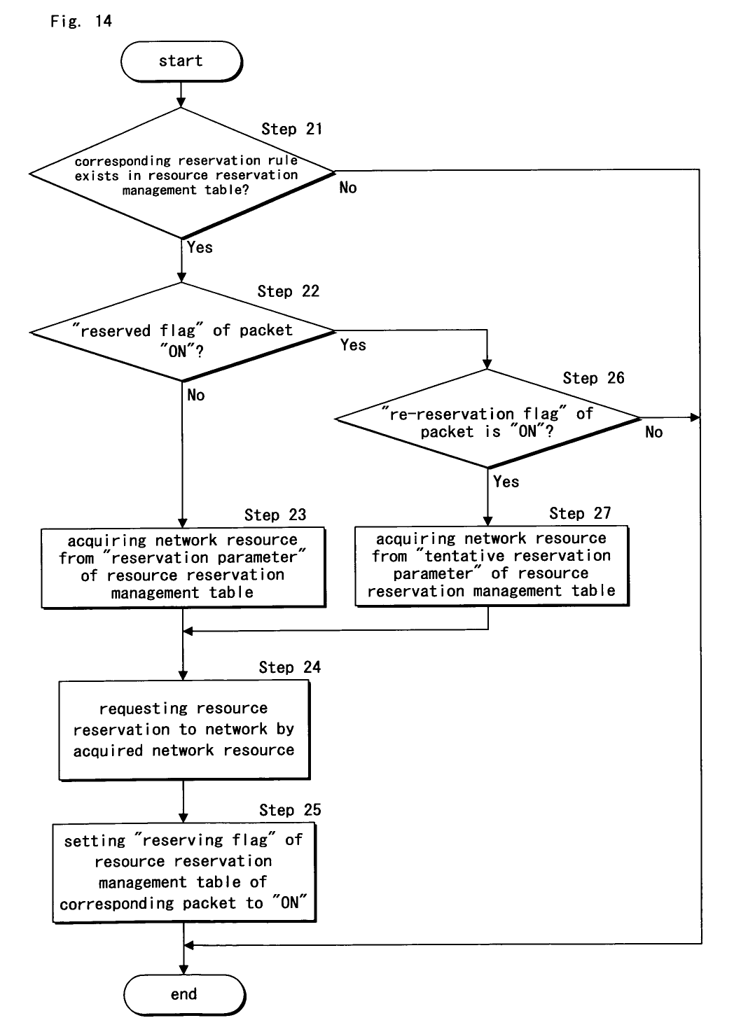

Next, operation of the resource monitoring unit 8 is explained referring to FIG. 13.

The resource monitoring unit 8 confirms whether or not the resource reservation management table 2 possesses the reservation rule entry corresponding to the packet via the reservation controlling unit 9 (Step 71). When the resource reservation management table 2 does not possess the reservation rule entry, the resource monitoring unit 8 ends the processing.

Since the reservation rule entry corresponding to the packet exists as shown in FIG. 17(b), the resource monitoring unit 8 acquires the value of the “reservation parameter” field, and the value of the “tentative reservation parameter” field from the corresponding reservation rule entry in the resource reservation management table 2 via the reservation controlling unit 9 (Step 72).

The resource monitoring unit 8 judges whether or not the difference of the values of the “reservation parameter” and the “tentative reservation parameter” are larger than the fixed value (for example, a 10% increase in the average bit rate) at Step 73. When the difference of the values are larger than the fixed value, the resource monitoring unit 8 sets the value of the “re-reservation flag” field to “ON” via the reservation controlling unit 9 (Step 74).

In the present embodiment, the value of the “reservation parameter” has changed to the value of the “tentative reservation parameter” by more than 10% of the fixed value, or specifically from “6 Mbps” to “8 Mbps”, therefore, the resource monitoring unit 8 sets the value of the “re-reservation flag” field to “ON” via the reservation controlling unit 9. As a result, the resource reservation management table 2 becomes as shown in FIG. 17(c).

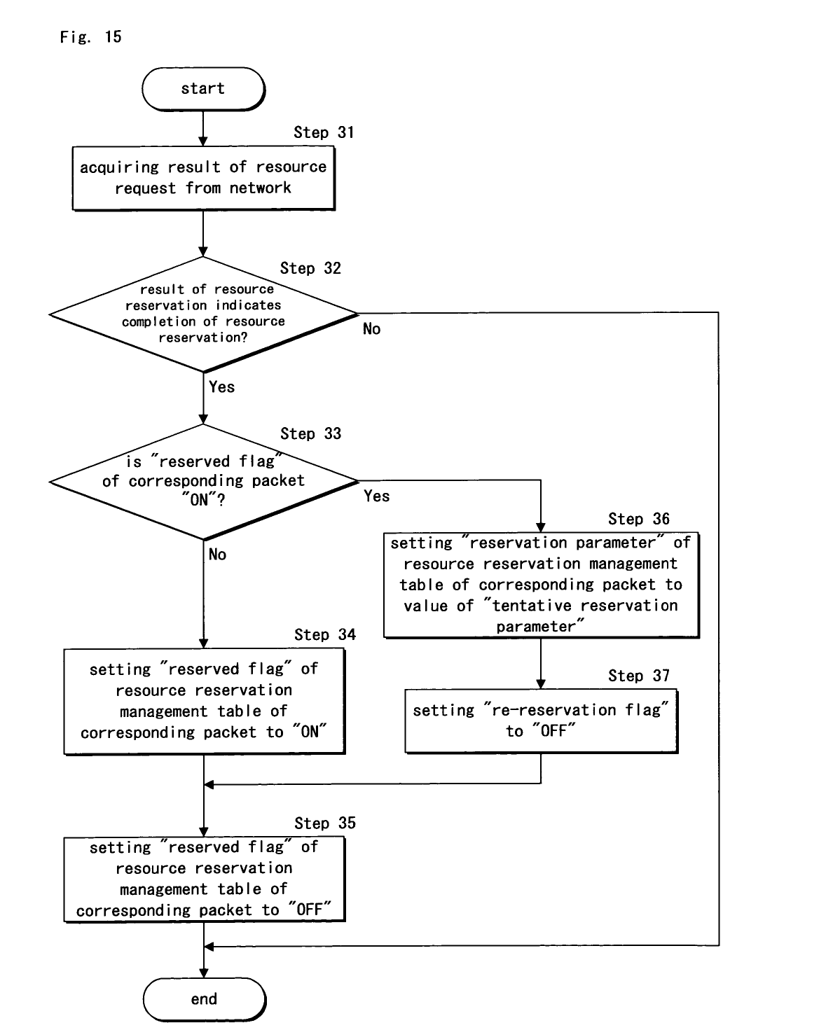

Operation of the resource allocation request unit 4 is explained referring to FIG. 14. Since Steps 21 to 25 are the same as those of the first embodiment, detailed explanation is omitted.

The resource allocation request unit 4 confirms whether or not the resource reservation management table 2 possesses the reservation rule entry regarding the packet via the reservation controlling unit 9 (Step 21). When the resource reservation management table 2 possesses the reservation rule entry, the resource allocation request unit 4 confirms whether or not the value of the “reserved flag” field is “ON” (Step 22).

In the present embodiment, the value of the “reserved flag” field is set to “ON” as shown in FIG. 17(c), then, the resource allocation request unit 4 confirms whether or not the value of the “re-reservation flag” field is “ON” via the reservation controlling unit 9 (Step 26). Since the value of the “re-reservation flag” field is “ON”, the resource allocation request unit 4 acquires the value of the “tentative reservation parameter” field as a network resource via the reservation controlling unit 9 (Step 27). Then, the resource allocation request unit 4 issues the reservation request to the network using the value (Step 24), and sets the value of the “reserving flag” to “ON” via the reservation controlling unit 9 (Step 25). As a result, the resource reservation management table 2 becomes as shown in FIG. 17(d).

Since operation of the communication period selecting unit 5 is the same as that of the first embodiment, explanation is omitted.

Then, operation of the packet transmitter 6 is explained using FIG. 16. Since Steps 51 to 57 are the same as those of the first embodiment, detailed explanation is omitted.

First, the packet transmitter 6 confirms whether or not the resource reservation management table 2 possesses the reservation rule entry regarding the packet via the reservation controlling unit 9 (Step 51). Since the resource reservation management table 2 possesses the reservation rule entry, the packet transmitter 6 acquires the value of the “communication period” field and the value of the “priority” field of the reservation rule entry via the reservation controlling unit 9 (Steps 52 and 53).

Next, the packet transmitter 6 confirms whether or not the value of the “communication period” field of the reservation rule entry is the “first communication period” via the reservation controlling unit 9 (Step 54). Since the value of the “communication period” field is the “second communication period” as shown in FIG. 17(d), the packet transmitter 6 transmits the packet in the second communication period 15 (Step 57).

The packet transmitter 6 further confirms whether or not the value of the “re-reservation flag” field is “ON” via the reservation controlling unit 9 (Step 58). When the value is “ON”, it means that the packet, which is already held in the reservation rule entry, can not be transmitted in the second communication period 15. In this case, the packet transmitter 6 transmits the packet in the first communication period 16 based on the priority that is set in the reservation rule entry (Step 59).

When the traffic is streaming at the value larger than the value of the reservation parameter which the resource allocation request unit 4 has requested to the network, packet that can not be transmitted in the second communication period 15 is transmitted in the first communication period 16. More specifically, the current traffic has the average bit rate of 8 Mbps, in the present embodiment, and the reserved parameter is the average bit rate of 6 Mbps, the packet of 2 Mbps in the average bit rate, which is the difference between 8 Mbps and 6 Mbps, is transmitted in the first communication period 16. FIG. 4(d) illustrates the state of the network 1 at this moment, and the packet 201 is transmitted in both of the second communication period 15 and the first communication period 16.

(5) Transmission steps of a packet that is transmitted from the terminal 20 to the terminal 22 (after the re-reservation completed)

Steps are explained for communication device 10 to transmit a packet from the terminal 20 to the terminal 22 after the resource re-reservation is completed using a new reservation parameter.

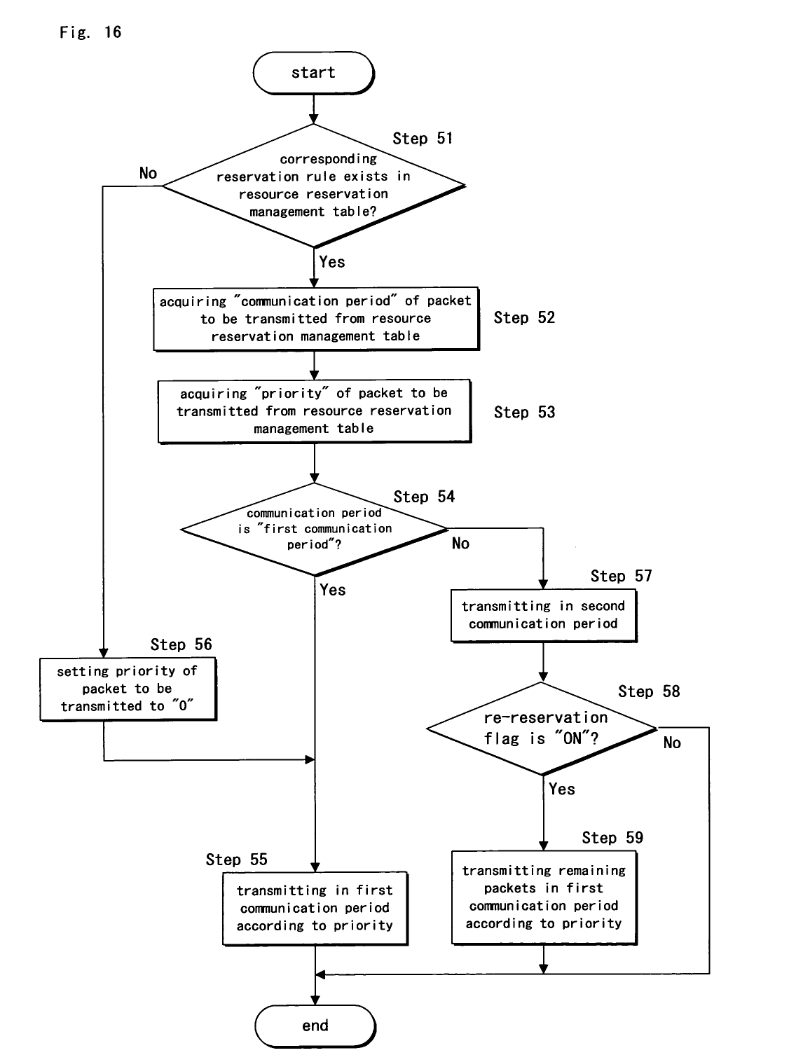

Operation of the resource request allocation unit 4 is explained referring to FIG. 15. Since Steps 31 to 35 are the same as those of the first embodiment, detailed explanation is omitted.

It is supposed that the resource allocation request unit 4 acquires the result of the resource allocation request from the network (Step 31), and the reservation is completed (Step 32). Since the value of the “reserved flag” field of the corresponding reservation rule entry is “ON” as shown in FIG. 17(d) (Step 33), the resource allocation request unit 4 overwrites the value of the “tentative reservation parameter” field of the corresponding reservation rule entry via the reservation controlling unit 9 onto the value of the “reservation parameter” field. Thereby, the value of the “reservation parameter” field is updated to the latest reservation parameter (Step 36). Then, the resource allocation request unit 4 sets the value of the “re-reservation flag” to “OFF” via the reservation controlling unit 9 (Step 37), and the value of the “reserving flag” field to “OFF” (Step 35).

The resource reservation management table 2 is updated as shown in FIG. 17 (e).

When the reservation using the new reservation parameter is completed, the packet transmitter 6 not only can communicate using the resource that is reserved by the latest reservation parameter, but also can communicate by using the second communication period 15 not using the first communication period 16.

FIG. 4(e) illustrates the state of the network 1 at this moment. After the completion of the reservation, the packet 201 is transmitted by using the second communication period 15 that is reserved again, and the packet 211 is transmitted by using the first communication period 16.

Thus, the communication quality can be secured by acquiring the reservation parameter of the packet requiring the reservation of the network resource by the measurement without the set up by a user.

Even in a case where a reservation parameter necessary for the packet changes after the resource reservation, re-reservation of the resource using the reservation parameter set after the change leads to securing communication quality.

While the re-reservation of the resource is being made, in addition to the second communication period, the first communication period is used for communication based on the priority. Thereby deterioration of the communication quality can be suppressed.

In the present embodiment, the average bit rate is used as the reservation parameter. Alternatively, a maximum bit rate, average frame size, maximum frame size, a jitter, and delay time may be used. The parameter that measuring unit 7 measures may be changed to corresponding parameters.

The resource measuring unit 7, which measures the network resource, is provided in the present embodiment. The resource measuring unit 7 may also be added to the first embodiment.

In the second embodiment, it is supposed that the reserved traffic composed of a collective set of packets exists. When the network resource required by the traffic is increased for some reason, the network resource necessary of the change can be adaptively reserved again. This is because the resource measuring unit 7 always measures the network resource that is necessary for the traffic.

Furthermore, until when the re-reservation is completed, the network resource reserved for the traffic is less than the currently necessary network resource. Even in such a case, communication quality can be secured not only using the second communication period but also using the first communication period as well.

After re-reservation is completed, the communication quality, which is guaranteed by the reservation, can be secured by using the second communication period alone.

According to the packet communication device of the present invention, communication quality of the communication requiring the reservation of the network resource can be guaranteed before the reservation of the network resource is completed. Therefore, a user can use any desired multimedia communication with secured communication quality and without time lag.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A packet communication device operable to compose a network substantially supporting a first communication period in which communications may be controlled at least by packet priority and may be carried out without reservation of network resources, and a second communication period in which communications may not be carried out without reservation of the network resources, said packet communication device comprising:
a packet receiver operable to receive packets;
a resource reservation information storage unit operable to store information on the reservation of the network resources;
a resource allocation request unit operable to refer to the information stored in said resource reservation information storage unit and also operable to issue resource allocation request to the network to transmit the packets in the second communication period when the packets received by said packet receiver are judged to need reserving the network resources;
a communication period selecting unit operable to select either of the first communication period and the second communication period to transmit the packets; and
a packet transmitter operable to transmit the packets using the communication period selected by said communication period selecting unit,
wherein said communication period selecting unit is operable to select the first communication period before completion of reserving the network resources in response to the resource allocation request issued by said resource allocation request unit, and
wherein said communication period selecting unit is operable to select the second communication period after the completion of reserving the network resources.

2. The packet communication device as defined in claim 1, wherein said packet receiver comprises a plurality of packet receiving units, and
wherein priority of a packet that needs reserving the network resources is determined depending on which of said packet receiving units receives the packet that needs reserving the network resources.

3. The packet communication device as defined in claim 1, wherein said packet communication device further comprises a resource measuring unit operable to measure reservation parameters currently necessary for packets that need reserving the network resources according to the information stored in said resource reservation information storage unit.

4. The packet communication device as defined in claim 3, wherein said packet communication device further comprises a resource monitoring unit operable to judge whether re-reservation of the network resources is necessary for packets that need reserving the network resources according to the information stored in said resource reservation information storage unit, by comparing the reservation parameters included in the resource allocation request issued by said resource allocation request unit and the currently necessary reservation parameters determined by said resource measuring unit, and
wherein when said resource monitoring unit judges that the re-reservation of the network resources is necessary, said resource allocation request unit is operable to issue resource allocation request based on the currently necessary reservation parameters.

5. The packet communication device as defined in claim 4, wherein, before completion of reserving the network resources in response to the resource allocation request based on the currently necessary reservation parameters issued by said resource allocation request unit, said packet communication device is operable to transmit the packets that need reserving the network resources using both of the first communication period and the second communication period only when the packets cannot be transmitted in the second communication period alone.

6. A packet communication device operable to compose a network substantially supporting a first communication period in which communications may be controlled at least by packet priority and may be carried out without reservation of network resources, and a second communication period in which communications may not be carried out without reservation of the network resources, said packet communication device comprising:
a packet receiver operable to receive packets;
a packet transmitter operable to transmit the packets received by said packet receiver in either of the first communication period and the second communication period in accordance with kinds of the packets; and
a resource allocation request unit operable to issue resource allocation request to the network, thereby transmitting packets that needs reserving the network resources in the second communication period,
wherein said packet transmitter is operable, according to the progress of the resource allocation request, to select either of the first and second communication periods to transmit the packets that need reserving the network resources.

7. The packet communication device as defined in claim 6, wherein said packet transmitter is operable, according to the progress of the resource allocation request, to switch from the first communication period to the second communication period to transmit the packets that need reserving the network resources.

8. A packet communication method to use a network substantially supporting a first communication period in which communications may be controlled at least by packet priority and may be carried out without reservation of network resources, and a second communication period in which communications may not be carried out without reservation of the network resources, the packet communication method including:
receiving packets;
storing information on the reservation of the network resources;
referring to the information stored in said resource reservation information storage unit;
issuing resource allocation request to the network to transmit the packets in the second communication period when the packets received in said receiving need reserving the network resources;
selecting either of the first communication period and the second communication period to transmit the packets; and
transmitting the packets using the communication period selected by said selecting,
wherein said selecting selects the first communication period before completion of reserving the network resources, and
wherein said selecting selects the second communication period after the completion of reserving the network resources.
